(19) United States
(12) Patent Application Publication
(10) Pub. No.: US 2003/0004825 A1
(43) Pub. Date: Jan. 2, 2003

(54) Sample administration process and system

(75) Inventors: Gregory J. Olson, Seattle, WA (US); Greg R. Hill, Woodinville, WA (US); David P. Geller, Sammamish, WA (US); Warren D. Stokes, Puyallup, WA (US)

Correspondence Address: BLACK LOWE & GRAHAM, 816 SECOND AVE., SEATTLE, WA, 98104, US

(73) Assignee: ALATRON Corporation

(21) Appl. No.: 09/952,785

(22) Filed: Sep. 13, 2001

Related U.S. Application Data
(60) Provisional application No. 60/233,466, filed on Sep. 18, 2000.

(51) Int. Cl. G06F 17/60

(52) U.S. Cl. 705/26

(57) ABSTRACT

A system and method for processing and administering requests for sample parts and materials. Parts, materials, or other items are requested by a customer on a client over a network. A server receives the item request and forwards it to the appropriate fulfilling party. An associated relational database is accessible by the server and stores information related to items, projects, customers, fulfilling parties, and the status of fulfillment and design feedback. Feedback is automatically solicited from and shared with customers and fulfilling parties.

### PRIORITY CLAIM

This application claims the benefit of earlier provisional application Ser. No. 60/223,466, filed Sep. 18, 2000.

### FIELD OF THE INVENTION

This invention relates generally to component ordering and tracking systems, particularly including systems and methods for ordering, monitoring, and updating samples and other components for use in product design, development, and manufacturing.

### BACKGROUND OF THE INVENTION

The development of a new product, particularly an electronic product, typically requires proof that the product will work and can be manufactured at a desired cost. In order to do so, product developers must find piece parts from the countless sources of such components, then build the product and test it. The process grows in complexity as alternative parts are tested and the developer must record data comparing various possible components with other possible components. Unfortunately, the present process for evaluating piece parts is typically a haphazard scrawl of engineering notes.

Worse yet, the parts vendors may not be aware of the magnitude of the product development—or even the existence of the development—and will not be prepared to supply the parts in the desired quantity or at the desired schedule. Even if the parts supplier is aware of the project, the supplier may alter or discontinue the part without telling the developer, leaving the developer with a finished product that cannot be built. The current state of affairs in the product development process is marked by these and other problems, as each of the many players in the process has particular needs and relies upon assumptions that are often based on faulty information.

Product Developers. Product developers are the drivers of sample related activity. They rely on samples to build prototypes of electronic or other products they intend to bring to market. In order to prove that their product designs work in small quantities prior to purchasing components in high volume, they order samples of every component in a design prior to manufacturing and purchasing. For some products a developer might make ten sample requests; for others hundreds or even thousands of such requests are made over the course of a product development cycle. Product developers presently can request samples from numerous sources including face-to-to face meetings with representatives, component manufacturers, and distributors; phone calls or emails to any of the above; or Internet-based requests from component manufacturers or manufacturers' representatives. In many or most cases, samples are provided for free. Nonetheless, developers sometimes find it more convenient to purchase component samples from catalog distributors such as DigiKey, Allied, or Newark.

When product developers request a sample they are asked for information about their company and their project in addition to the part number being requested. The company information and project information are restated or re-entered into computer databases for every request made, whether it is an online or off-line request. Because this standard information is not shared among multiple sample requests, the product developer or engineer must enter duplicative company and project related information for each sample ordered. This is a huge waste of time for the product developer, particularly for projects requiring hundreds or thousands of parts.

While part makers attempt to keep some data on samples being given away, only haphazard records typically are kept by the product developers that are requesting samples. This lack of information makes it difficult to determine the source of the parts once a decision is made to manufacture the product under consideration. In addition, the scant information that is available is not in a form that allows it to be shared with other product development teams, further complicating purchasing and manufacturing functions downstream.

Additional problems are created by the inability of the developer to manage parts data. For example, purchasing departments often do not get early visibility of product samples ordered by engineers, which can severely hinder production if a component has a long lead-time. Also, to the extent that a process for managing samples does exist within a corporate environment, it does not integrate the supply chain into the process. This adds to the environment of uncertainty for salespeople who are then left to follow-up almost randomly with engineers and purchasing agents. It also does not allow any of the involved parties to provide relevant information to other parties, such as notice of parts changes or that a sampled component was designed in.

When product developers purchase component samples from catalog distributors, they create a disincentive for the sales and technical resources that actively service the product developer's account. This can impede the viability of the entire project by increasing component prices (due to the absence of early visibility), reducing component availability (due to unforeseen inventory needs by the distributor), or exposing the project to other problems (due to product change notifications, errata, or related information that is not shared in time).

After a sample request is made by a product developer, parts sellers eagerly contact the developer in attempt to make sales. Engineers typically prefer to avoid parts salespeople, believing that is the job of purchasing personnel. But, as a necessary evil in order to obtain samples, engineers reluctantly continue to meet with sales personnel. After a part is sampled, the sales force repeatedly follows up to see if the part will get designed in and purchased. This request for feedback is usually disruptive and nearly always comes at the wrong time.

Component Manufacturers. Component or parts manufacturers rely on sampling activity as a leading indicator that their components will be designed into a product and later purchased. No component is purchased in high volume without first being sampled and approved.

Manufacturers sell and distribute components in several ways, including through manufacturer representatives and distributors. Manufacturer representatives are an independent direct sales force of component manufacturers, while distributors are additional sales resources that schedule and ship components to customers. Component manufacturers may receive sample requests directly or through their network of representatives and distributors. Even though distributors carry inventory, most samples are fulfilled directly from component manufacturers' sample stock.

Component manufacturers need product developers to be exposed to their products and sampled at the proper time when there is a qualified need. In order to qualify the need they require certain information including company information, project details, and project status.

After the samples are shipped to the customer or representative (for subsequent delivery to the customer), the component manufacturer needs feedback regarding the samples it provided. For instance, the manufacturer would like to resolve any technical hurdles that the product developer might face. Unfortunately, customers are spread throughout the world, making it very expensive to support them directly in all territories. Consequently, product developers rely heavily on their manufacturer representatives and franchised distributors. Because information collected by the sales channel regarding the sample opportunity or subsequent status is often incomplete or inaccurate, it is difficult for the representatives and distributors to serve as the intermediary.

Although samples are the most important leading indicators of new design activity and future revenues, component manufacturers do not earn money by managing sample related activity. As such, sample-related activities are often overlooked. In the long run, by ignoring sample activity component manufacturers fail to reach product developers at an early stage when product designs can be influenced.

When a component is designed out, the component manufacturer frequently does not know why until it is too late to affect the decision. If the manufacturer received feedback in time, it may have been able to help the product developer by resolving technical problems or providing information. Unfortunately, the lack of information and product development visibility prevents the manufacturer from providing such assistance even though it may have resulted in substantial sales.

Further complicating the sample process is the fact that many companies are fragmented in that they design in one location and manufacture in another location. Parts manufacturers can lose sight of projects when samples are provided to one location but orders are taken from another. These fragmented customers often receive fragmented support, particularly when commissions are paid to a supplier unaffiliated with the source of the original sample.

Manufacturer Representatives. Manufacturer representatives also rely on samples as a leading indicator of future revenues. However, representatives are driven by their best accounts. They are independent sales organizations that are paid on sales results. They generally represent many manufacturers, usually five to twenty, and focus on high volume opportunities within their territories. They are regional in nature and must split commissions with component manufacturers when components are designed into products in their territory but purchased outside of their territory.

Representatives have as many as three sets of customers—the end customers that purchase components, the manufacturers they represent and the franchised distributors that resell the manufacturers' components. Without either the manufacturers or end customers the Manufacturers Representative would not exist and it is imperative that the manufacturer rep coordinate sales activities with the distributors. Today, representatives seemingly treat sample requests for all product developers equally in order to prevent negative feedback from reaching their principals. Although all customers want to be treated equally, treating all customers equally is not a good business practice for the representative because most sample requests do not lead to high sales volumes. Consequently, representatives may favor some customers over others depending on the expectation of commissions.

Representatives receive sample requests through phone calls or emails from distributors or product developers. Some have Internet sites that allow product developers to request samples or information. Manufacturer representatives process sample requests differently according to each manufacturer they represent. Process methods include fax, email, Lotus Notes, SAP, and phone.

Representatives also need a wealth of information in order to succeed, but have difficulty gathering it. They must manage the activities of the distributors that are associated with their lines, resolving conflicts that result as competitive distributors vie for the same sales opportunities within a region. When interviewing to earn new lines or retain existing lines, representatives are evaluated on their territory knowledge and presence as well as their ability to track, manage, and report opportunities. Unfortunately, it is difficult for representatives to gather and maintain the desired information, which is often collected in person. For example, field sales personnel visit product developers and meet with the distributor sales departments in order to solicit information about components that have been sampled.

Representatives need a system that will allow them to obtain information about samples and the development of products using those samples in a manner that is fast, inexpensive, and allows all customers to be given a similar level of service.

Direct Sales Offices. Direct sales offices are extensions of the component manufacturer. The problems they face are similar to those of the manufacturer representatives except that they represent only one manufacturer.

Distributors. Distributors also view samples as a leading indicator to a sale. In fact, distributor salespeople often rely on samples, e.g., hold them hostage, in order to visit an engineer and learn about a project. Distributors are on the bottom of the component sales food chain. Getting samples approved does not guarantee the distributor business because they usually have to compete with other distributors that carry parts from the same manufacturer.

Components that are requested as samples are often not in distributor inventory. If they are, the distributor may provide the sample for free and attempt to get reimbursement from the component manufacturer at the end of the period. If they are ISO 9002 certified they are less likely to sample small quantities that break reels or split tube quantities. Because of these constraints and other limitations they usually try to get sample fulfillment directly from the component manufacturer.

Component manufacturers are reducing the number of accounts they handle directly, instead servicing accounts through distributors. As these distributors earn the rank of preferred supplier, they become responsible for added duties such as the continued distribution of product change notifications and other technical information.

As the number of parts and accounts grows, it is increasingly difficult for a distributor to keep a sales force up to date on the products that it carries (usually 25-400 manufacturers each with hundreds or thousand of products). It is also increasingly difficult for distributor salespeople to keep up with all of the changes in their account bases as customers move in and out of the territory and design in one location and manufacturer at another. The distributors feel the worst of customer fragmentation because they are largely regional at the operational level.

Distributors are sales organizations. Their sales personnel are focused on opportunities that they perceive will earn them sales commissions. Free component samples do not pay immediate commissions and may never lead to high-commission sales later. Because of this, there is poor sample tracking within distributor organizations. If a sample does not represent a sales opportunity in the short run then it is most likely ignored. Likewise, a product change notification that could be critical to the product developer does not represent a sale and is often ignored by the distributor's sales and technical force. Even if the distributor truly wanted to route product change notifications to its customers, it lacks a reliable routing mechanism and relevant database by which to do so. Sales force turnover also remains high, usually 40% per year, which further depletes the internal account knowledge of the distributors and diminishes the quality of service received by product developers.

Accordingly, there is a need for an improved system and method for ordering, monitoring, and updating samples and other components for use in product design, development, and manufacturing.

### SUMMARY OF THE INVENTION

The present invention comprises a system and method for processing and administering requests for sample parts and materials. In a preferred embodiment, parts, materials, or other items are requested by a customer on a client over a network. A server receives the item request and forwards it to the appropriate fulfilling party.

In accordance with other aspects of the invention, an associated relational database is accessible by the server and stores information related to items, projects, customers, fulfilling parties, and the status of fulfillment and design.

In accordance with further aspects of the invention, customers requesting parts may either enter part numbers or codes identifying the part, or may select parts from listings of part numbers and manufacturers. In the event customers enter part numbers via a keyboard connected to the client computer, software running on the server evaluates the part number to determine whether it is valid. If it is not, the customer is offered assistance in building a correct part number.

In accordance with other aspects of the invention, the fulfilling party is notified by the server when a customer requests an item. The fulfilling party can be the part manufacturer, a distributor, manufacturer representative, or other entity. In addition, other parties are notified of the request if the fulfilling party indicates that other parties should be notified.

In accordance with still further aspects of the invention, the fulfilling party may be notified in a variety of ways, preferably including an email message. If the fulfilling party requires a particular order form, the form is stored in a database accessible by the server and automatically completed by the server for submission to the fulfilling party. Accordingly, customers enter data in a standard format, but fulfilling parties receive the request in a different format if desired.

In accordance with yet other aspects of the invention, software operating on the server periodically accesses the database to assess the status of various projects and item requests. Depending on the stored status, the server automatically sends requests for status updates to fulfilling parties, customers, or other parties. Among the information requested of fulfilling parties is whether the item request has been received or approved; whether the item has been shipped; the anticipated ship date; and whether there are any change notices affecting the item. Customers are asked whether the item has been received; whether the item has been adopted for inclusion in the project under development; and whether the item has been assigned an internal part number. Status information received from fulfilling parties is sent to customers, and status information received from customers is sent to fulfilling parties.

In accordance with still further aspects of the invention, customers are promptly informed of change notices affecting parts. Accordingly, when a fulfilling party sends a single message to the server indicating that a part has been changed or is no longer available, all customers having active projects stored in the database will receive corresponding notices. In this manner, customers will have the information necessary to avoid designing a product that relies on obsolete or discontinued parts.

In accordance with still further aspects of the invention, fulfilling parties are informed when parts are needed and expected to be used in a product design. The consistent exchange of information enables manufacturers to be prepared when parts orders are submitted.

In accordance with yet other aspects of the invention. users are able to view the status of a project or items requested by accessing the server over the network. Depending on the permission level of the user, the user can update the status of information stored in the database.

In accordance with yet other aspects of the invention, users can request reports based on data stored in the database. For example, a manufacturer can obtain a report indicating all sample parts provided by that manufacturer. Likewise, distributors, manufacturer representatives, customers, and others can obtain reports summarizing active projects and items they are involved with.

### BRIEF DESCRIPTION OF THE DRAWINGS

The preferred and alternative embodiments of the present invention are described in detail below with reference to the following drawings.

FIG. 1 is a block diagram of a sample administration system in accordance with the present invention;

FIG. 2 is a block diagram of network system architecture in accordance with a preferred embodiment of the present invention;

FIG. 3 is a flow chart of a portion of the sample administration process in accordance with the present invention;

FIG. 4 is a flow chart of a portion of the sample administration process in accordance with the present invention;

FIG. 5 is an exemplary reporting format in accordance with the present invention; and

FIG. 6 is a depiction of an administration tool presentation in accordance with the present invention.

### DETAILED DESCRIPTION OF THE PREFERRED EMBODIMENT

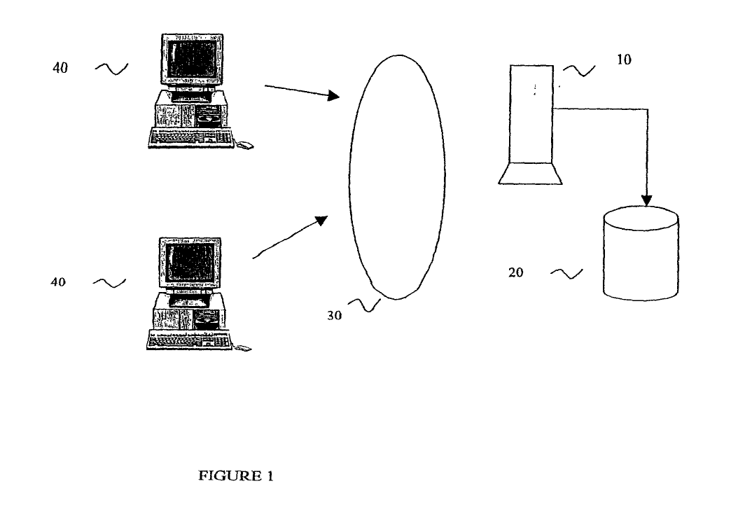

A block diagram of the preferred sample administration system is shown in FIG. 1. The system includes a server 10 having an associated memory 20. The server 10 is any microprocessor-based device capable of communicating with other microprocessor-based devices over a network 30. In addition, although one server is illustrated, multiple servers can be used to distribute tasks or handle large traffic loads. The associated memory 20 is a hard drive, zip drive, optical storage, magnetic tape, or any other data storage device accessible by the server 10 and capable of storing the sample administration data described further below. The memory 20 is preferably co-located with the server in the same physical box. Alternatively, the memory 20 can be located remotely from the server 10, including at a physically remote location accessible over the network 30. The server 10 is accessible over the network by any number of remote clients 40. The clients 40 are desktop computers or other microprocessor-based devices such as notebook computers, personal digital assistants (PDAs), cellular phones, or other devices. The network 30 is the Internet, although any wired or wireless network architecture can be used to enable the remote clients 40 to communicate with the server 10.

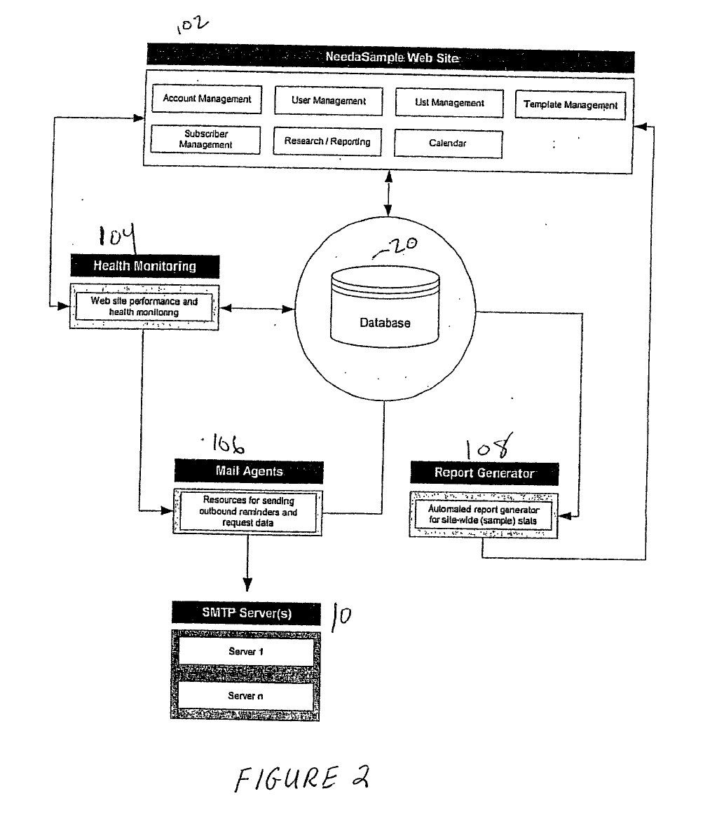

FIG. 2 depicts the system architecture, including the relationship between the various components that are visible to users, the database, and the ancillary tools that also access the database. As best seen in FIG. 2, the database is both a central depository for application-wide and customer-specific data and a mechanism for signaling tasks between the components. For example, some outbound e-mail is generated by mail records contained within a special database table.

As discussed further below, information is entered in a form through which project developers describe their projects and request samples. The data provided by the developers populates the database that is used for the purposes of information management, reporting, and serves as the basis for either obtaining or pushing additional relevant information. The relational database contains many types of information including names for component manufacturers, part numbers, strategic part numbers (for their registration program if applicable), franchised distributors, manufacturer representatives, direct sales offices, contact data for all of the above, project related data for the product developer, sample status, and product change notifications and or related information. While the database is preferably populated principally by sample requests, it may also be updated or modified by system administrators who obtain information through other channels.

Web site application software 102 is stored in the memory 20 or in any other accessible storage medium and executable by the server 10 to enable it to perform functions related to collection and monitoring of sample activity. These functions include:

Account and Administrative Management. The account and administrative management component manages the various accounts, controls registration, and provides other administration. It interfaces with the registration tables in the database and is used to control access to the site.

List Management. The list management tool is used to send personalized emails to users. These personalized emails may contain marketing material related to the inventing company or other companies, in addition to data that is pertinent to samples users have requested through the system. Examples of this data include product change notifications or supplier change notifications. Users may unsubscribe to this feature.

Subscriber Management. The sample administration system offers different levels of features to manufacturers or other users depending on whether they are subscribers of the service. The subscriber management component interfaces with the database to ensure that the proper services are provided to each user.

Calendar. The calendar component tracks time to support other components that take actions at specified times.

User Management. The user management component manages user aspects including registration, security levels, and user information. It interfaces with the database as necessary to associate users with projects, parts, or other matters.

Template Management. The template management component is part of the content delivery tool set that provides content to users accessing the system over the network. The template manager controls HTML templates on the site that are used to create and deliver web pages to clients.

Research and Reporting. The research and reporting tools are used to track traffic and behavior patterns on the site, including identification of the users, the number of pages viewed, time spent on the site, and other statistics. Data are stored in the database and collected and presented in a variety of formats using presentation software such as Crystal Reports.

Health Monitoring. The health of the site and the database is monitored by software running on several different systems. When problems are detected, alerts are generated and e-mailed to system administrators via records stored in the database. In the case of database failure, the health monitoring tools communicate with one or more SMTP servers directly.

E-Mail Agents. The E-mail agents read outbound e-mail requests and data stored in the database and create e-mail messages to be sent through one or more SMTP servers.

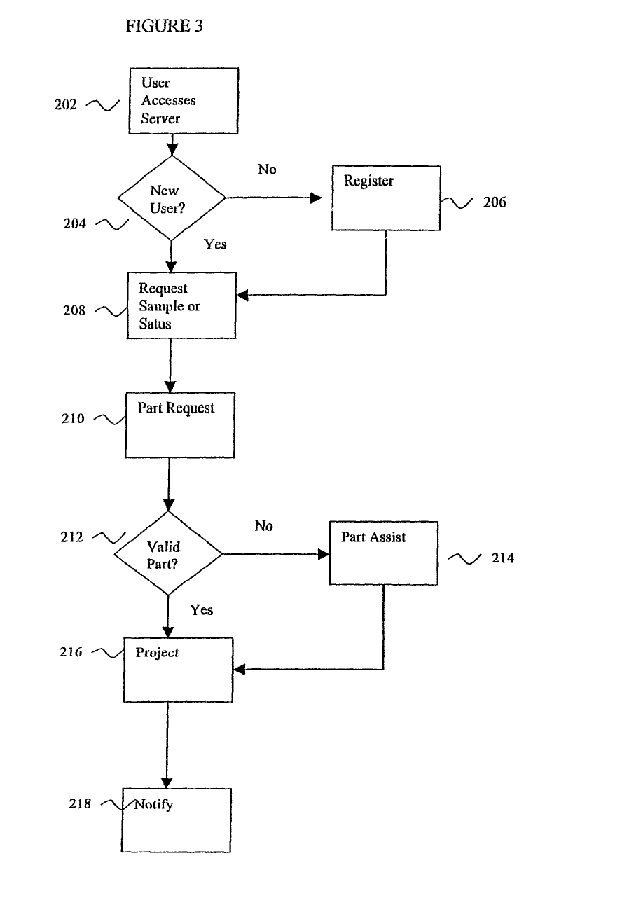

The sample administration process using the architecture of FIGS. 1-2 is depicted in FIG. 3. Using a client computer 40, a user accesses the sample administration web site or affiliate site at a first block 202. Preferably, the user accesses the system web site by entering the system domain name or IP address into a browser application operating on the client 40.

Manufacturers, distributors, representatives, or others may become “affiliates” of the sample administration by paying affiliate fees or entering into affiliate agreements. Affiliates that operate Internet sites preferably include a link (such as a domain name or an executable icon) that redirect users to the system web site.

After accessing the system web site, users are asked to login with a password at block 204. Though the use of passwords and a user login is preferred for security reasons, the system and method will work without passwords or other security features. Users will typically request samples personally, although a user may have another user enter a sample request on his behalf. Those requesting samples for others can include salespersons, colleagues, applications engineers, and others. If the user has not previously registered (and therefore has no login name or password) the user is prompted to do so at block 206. The registration process collects data such as the developer company name, the user name, address, phone and facsimile numbers, and email address.

After login or initial registration the user is given choices at block 208, including Order Sample or View Status. Selecting either one of these (for example, by “clicking” an appropriate button with a mouse or typing corresponding keys with a keyboard) will launch the respective applications. If the user selects the Order Sample option, the process proceeds to block 210 at which the system begins collecting information to enable it to provide a sample.

In order to select a part to sample, the user enters a manufacturer and a part number in their respective boxes presented on the display of the client computer. Alternatively the user can lookup a manufacturer or part number using a search tool or can select from a pull-down menu of manufacturers and the parts offered by those manufacturers. The manufacturer and part listing is obtained by accessing the database 20. Manufacturers may add parts to this list through an administration tool or integration kit that is provided to manufacturers as requested. Alternatively, manufactures can send written, email, verbal, or other notice to system administrators who will update the database accordingly.

The parts and manufacturers data is associated with additional data as specified by manufacturers. Principally, the additional data is a notification code that instructs the system to provide particular notifications if certain parts are requested. For example, when a particular part is ordered, a manufacturer may want to be notified immediately, or may want a distributor to be informed so that a prompt follow-up contact is made. A request for other parts may trigger prompt requests for government or other approvals that might be required. In some cases, the request for specific parts by specific customers can trigger a notice to distributors or representatives that special pricing arrangements or inventory allocations apply. Still other parts might have no entry in the database for special notifications.

After the desired manufacturer part number is selected or entered, the user clicks the Next button to proceed or the Back button to return to a previous step.

The system then proceeds to block 214, where the entered part number is verified. If the user provides an incorrect part number he is given a message that the part number is incorrect. This message will also contain links to information that is necessary in order to build a correct part number. The user is also offered access web-based customer assistance in order to build a correct part number with the aid of a live operator. The source of customer assistance may be from the system administrator, component manufacturer, distributor, manufacturers rep, direct sales office or third party.

After a valid part number has been entered or selected, the process proceeds to block 216 to collect project information from the user. The project information relates to the device under development. The project information is preferably collected via an on-line form that is completed at the client 40 and submitted over the network 30 to the server 10. Alternatively, the project information can be submitted verbally, via email, by facsimile, or in any other form. Regardless of the form of submission, the information (or a subset of it) is ultimately stored in the database 20.

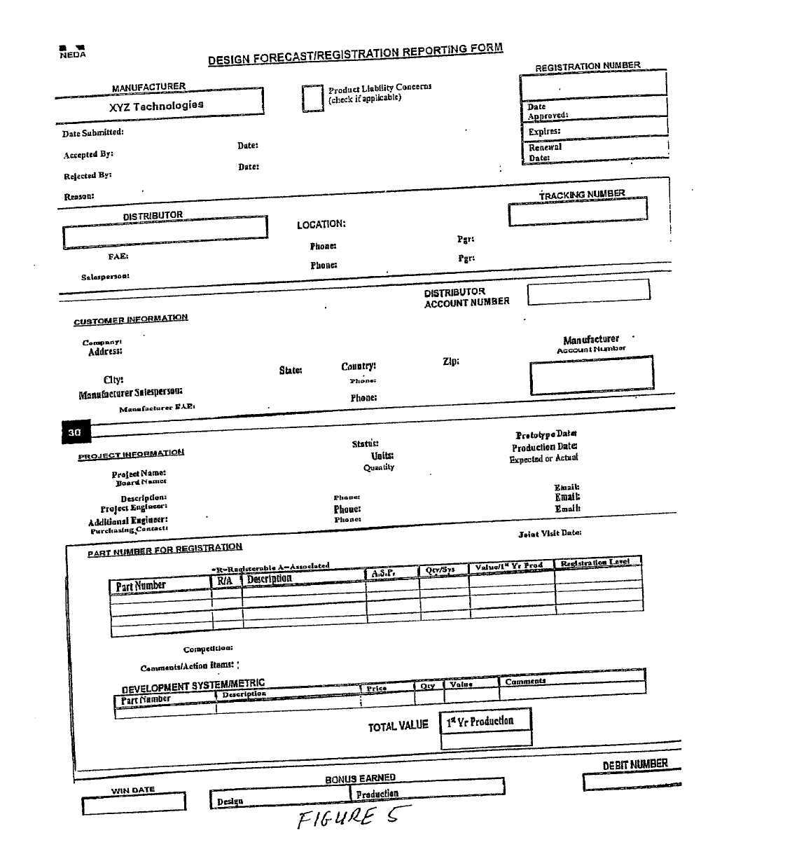

A preferred project registration form is depicted in FIG. 5. The form of FIG. 5 includes examples of the type of information that is collected. Among the information supplied by the customer is the name of the project, the estimated quantity of parts expected to be purchased if the part is designed in, the evaluation period expected, and contact information for project team members.

If the user is ordering a sample for a previously registered project, the user can select from any projects associated with that user to use the previously entered project information, eliminating the time required to enter the information over again. When registering a project or entering information for a new project, the user is given the option of viewing the terms and conditions of a sample request for each component manufacturer. After the user enters the required information (or selects an active project), he clicks the Next button to proceed or the Back button to return to a previous step.

After registering or selecting a project, the process proceeds to block 201, Notify, at which the user can select to notify others that are related to the project or supply chain. Some of the parties needing notification, such as co-workers working on the same project, will be known to the user. For such parties, the user will enter the contact information such as names, addresses, phone numbers, and email addresses. Other parties such as manufacturers, representatives, distributors, or others, will be unknown and will appear on the client display as additional resources that may desire notification. A comprehensive database will correlate component manufacturers, manufacturer representatives, and franchised distributors in all of their various locations. This is valuable to the user, who otherwise would be unlikely to have such contact information and therefore no means to communicate with them about project and part status. The user selects parties from the list of additional companies and people by using a simple radio button interface. The resources that are checked or otherwise selected are then notified electronically via email or by another means of the sample request. The actual notice can be a prompt notice that a part has been requested, notice of the project details, and other subsequent notices about the status of the project such as that a part has been designed in. Once all of the notification parties have been selected, the user clicks the Send button to complete the sample request or the Back button to return to a previous step.

The user is then presented with a browser message that thanks them and indicates that the sample request is being processed. The user then closes the sample request window. If desired, the user can return to block 208 to begin the process for a new sample, can view the status of any registered projects, or conduct other business on the site.

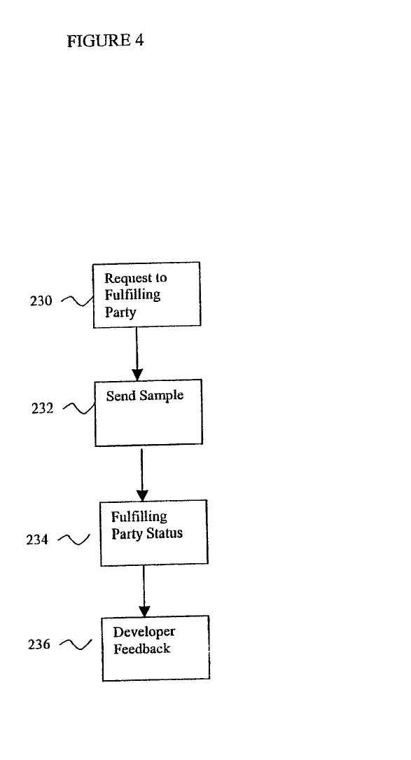

With reference to FIG. 4, after a part has been requested by a user using the process of FIG. 3, the process proceeds to block 230 at which the request for a sample is submitted to a manufacturer. Although manufacturers are the preferred source of sample parts, manufacturers or other entities can designate other parties to service requests for samples. In such cases, the sample request will be directed to the designated party.

The sample software will populate manufacturer sample request or fulfillment forms automatically along with the time and date of the original sample request. Manufacturers, representatives, distributors, or others may submit a preferred order format that is then electronically stored in the database 20. Once a user submits a request for a particular part, the server 10 will access the database 20 to determine whether the fulfilling party has indicated a preferred form for parts requests and has submitted a request form. If the database contains a preferred form associated with the part or fulfilling party, the system will use that form to submit the sample request. If a specific manufacturer form is not present in the database then the system will detect this and populate a generic substitute form in its place. The generic form or the specified form are both populated in the same manner. In either case, the forms include a number of fields such as contact information for the requesting party, the part number, project information, tracking numbers, or any other information that might typically be included in a request or fulfillment form. The server draws such information from the database and uses it to populate the form, which is subsequently sent to the fulfilling party.

The information contained in the request submitted to the manufacturer is dependent upon whether the manufacturer is a registered program participant. If the manufacturer is a program participant, the sample fulfillment occurs according to the provisions of the manufacturer integration kit and administrative setup as described below. The preferred features include automatic notification via email to the direct sales office, manufacturers representative, or both, and optional notification to the applicable franchised distributors. However, if the distributor participated directly in the fulfillment at the request of the component manufacturer then the distributor will receive a default notice as well. The notification message will include details about the developer and the project as submitted by the developer.

Non-participating component manufacturers will receive an occasional email message indicating that a sample request has been made and directed to their manufacturer representative or direct sales office for conventional processing. However, some of the project details or other information may be withheld. In addition, report generation and other capabilities are withdrawn in order to entice the manufacturer into the program. The occasional notification email will also include a link to find out more about becoming a participant.

After the manufacturer (or distributor or representative) receives a sample request, the process proceeds to block 232 where sample fulfillment occurs. Sample fulfillment is performed according to the component manufacturer's administrative setup and integration kit. The integration kit encompasses a wide range of technologies including manual, conventional and web-based fax, email, extensible markup language (XML), electronic data interchange (EDI), Internet Content and Exchange (ICE), and others. The particular technology used will vary by component manufacturer, depending on the manner in which the manufacturer prefers to receive and process sample requests. The component manufacturer may also use an intermediary, manufacturer's representative, or other to process the order.

Regardless of whether the manufacturer is a program participant, the minimum information required to process a sample request is provided. However, in a preferred embodiment only participants using the software service will be able to view complete data, process requests and communicate through the system. The sample request is fulfilled and shipped to the customer or the representative at the discretion of the component manufacturer.

After the sample request is received by a member of the supply chain, the system proceeds to block 234 where it solicits a member of the supply chain, i.e., manufacturers' representative, component manufacturer, or distributor, to provide sample status. The sample status solicited includes (1) whether the manufacturer received a valid sample request; (2) whether the sample is available and its anticipated ship date; (3) whether the sample has been shipped to the developer; and (4) whether there are any change notifications or other information pertinent to the requested part. In the preferred embodiment, the status is entered through the same website where the sample was requested from. The status may alternatively be managed through a companion web site or any other location accessible over the computer network. In either case, sample status data collected is stored in the memory 20 as part of the database. If sample status is not provided in a timely manner (preferably four days, but may be any period, as desired) then the system generates an email to the supply chain members asking them to provide sample status.

At various times the mail agents 106 (see FIG. 2) access the database 20 to determine the status of the sample requests and send automated email messages. Users can change the status of the sample by clicking on links contained in emails or by accessing the system via the Website. Changes in status are written to the database upon submission and saving changes while logged in or when users exit the system. Any time a change in status occurs the database is updated and notice or solicitation emails are pushed to the relevant parties.

At a next block 236, feedback is solicited from the developer or engineer. Although FIG. 4 illustrates status being solicited from the manufacturer before feedback from the developer, this can be sought in the opposite order or in parallel. In the preferred embodiment, status is sought continually until the part has been indicated as shipped, and feedback is sought continually until it has been indicated as received, designed in, assigned an internal part number, or no longer being considered.

The developer receives auto-generated emails throughout the life of the project that provide updated status on the samples ordered. Some of the notices are automatically generated emails that are sent when the component manufacturer or agent enters a status change for a sample request. Thus, the developer is sent a notice that a sample request has been received by the manufacturer, the anticipated ship date, and a notice of shipping. If the manufacturer submits change notices related to a particular part, every developer with an active project using the sampled part receives a notice of the change. The emails sent to developers are filtered, or organized to be sent to particular parties, as appropriate. Thus, for example, when product change notices are sent to developers to inform them that a part has been changed or discontinued, the system accesses the database to determine who should receive notices. The data accessed may include, for example, manufacturers, product families, dates when parts were manufactured, or others.

The parts manufacturer also receives feedback that is solicited from the developer. The principal feedback elements are (1) whether the sample was received; (2) whether the sample was approved for incorporation into the product under development; and (3) whether an internal part number has been assigned. Emails soliciting the above feedback information are sent to the developer in the same manner as those emails sent to the manufacturer soliciting status. The developer can click on links in the email received in order to provide satus or they can login to the system and enter feedback directly into the system using the process/update tab available for each sample request in the system. When changes are made, the database is updated accordingly and notices are sent to the manufacturer and any other designated parties.

The component manufacturer's sample administrator pushes sample related information to any of the parties they designate using a sample administrator that is available on the website where sample requests are entered or with a companion Website as discussed above. As a default setup or if a component manufacturer is not a registered participant, the direct sales office and manufacturer's representative in the respective territory of the sample request shall be notified. If a component manufacturer is not participating in the sample software service then a surrogate administrator will act on its behalf. This surrogate administrator will be an employee of the developing company.

Component manufacturers that are participants can direct sample related information to additional parties. One example is email notification to product marketing groups in the event of a sample request of a strategic component or sample requests by a strategic market segment. Another example is an email notification to groups that provide field support for complex products. Yet another example includes email notification to the registration coordinator when a sample request for a registration-classified component occurs (design-win component). Another example is email notification to the group handling literature requests or other promotional items.

Manufacturers, developers, or other users can also push information to other participants at their discretion. Thus, users can share information with others that are not directly related to the sample request, such as a favorite distributor salesperson, colleague, subsidiary, or other entity. The product developer has an individual or corporate administrative tool in which they can provide contact information such as their preferred suppliers list and contact information. These contacts can be viewed and optionally notified via email of a sample request during the notify step at block 218.

Product developers can choose to share access to the sample administration system with a development team or an entire company. By using an administrative tool the corporate administrator can set up information sharing within the corporate environment, giving sample related visibility to parties internal to their organization. Some of these parties may include people within marketing, research & development, engineering, purchasing, manufacturing, accounts payable, manufacturing, quality assurance, management, or others. This keeps all parties involved in the New Product Development team apprised of samples and related activity.

The principal areas of feedback that various parties to the corporate program may be interested in are (1) that a sample request has been made; (2) that a part has a change in status; (3) that a part has been approved or not approved; (4) that an internal part number has been assigned; (5) that the part is subject to a change notification; and (6) that the part has been quoted. The above information is updated as necessary and stored in the database.

The information is shared either by sending email or other forms of notice to participants when changes are made, or by allowing participants access to the database to determine the state of the project at any time. Where database access is used, permission sensitive access is granted to different personnel. Any user can login as in step 204 (see FIG. 3). Each registered user is also assigned a permission level that governs the extent of access to the database that is granted. After logging in as a registered user, the user can elect to view the status of any project or sample request. The extent of information displayed for the user is governed according to the permission level. Further, the ability of users to request samples or conduct other actions is controlled by the associated permission level. For example, technicians may be able to view status, but not enter sample requests. Also, engineers may be able to view pricing and availability but generating a quote may be a privileged function enabled only for purchasing agents. These different permission levels are determined by the company business rules and entered through the administration tool.

Any user or participant can generate reports according to their profile and permission level. If engineers have ordered samples in the past through the system, they are able to generate historical reports for all of their company's sample activities. Representatives, however, are only able to generate reports on those manufacturers that they represent. Likewise, component manufacturers can generate reports for multiple representative territories, and multiple product developers, but only for samples that they provided. The system provides paying customers with enhanced information and reporting capabilities and provides aggregate level information in order to entice people into the sample program. The reports are generated through the view status portion of the web site. Standard reports are generated through a dropdown box or by using a report generation wizard. Alternatively, third party report tools such as Crystal Reports may be used. Users can also sort sample related information, viewing it in detail or summary form. Users can also print reports directly from the application. Further, information can be exported from the application into standard text files for later import into word processors, spreadsheets, or other applications. Reports generated by distributors can look like standard NEDA (North American Electronic Distributor) design forecast/registration reporting forms as shown in FIG. 5.

Users can access the database to make changes as necessary using an administration tool. The administration tool is best suited for manufacturer's representatives, who likely have many manufacturers they represent and many developer customers they service. Consequently, the tool will be described here with those in mind. It can also be used, however, to enable developers, manufacturers, and others to access and modify data stored.

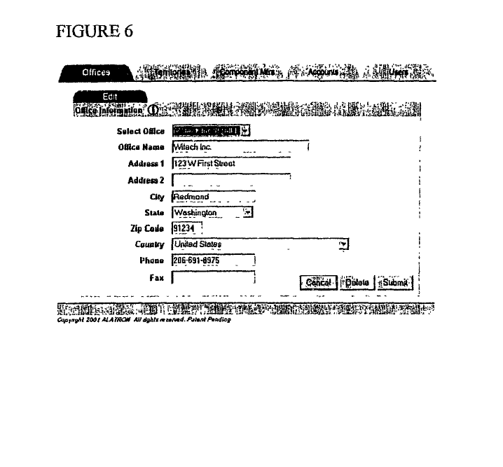

One or more users per representative firm is designated as the administrator. The administrator accesses the administration tool via a client machine 40 in communication with a server 10, such as illustrated in FIG. 1. The administration tool presents the user with a number of categories of information that can be reviewed and modified, presented in a tabbed format as illustrated in FIG. 6. Many of the tabs also include sub-tabs with additional information that can be modified and reviewed. The principal tabs in the administration tool include:

Offices. This tab includes location and contact information for the firm offices.

Territories. This tab designates territories served by the office. Territories can be added, deleted, or amended. Preferably, territories are defined by zip code, but can also be indicated by states, counties, cities, or other designations.

Component Manufacturers. This tab provides a listing of manufacturers represented by the user. Manufacturers can be added or deleted using the tool.

Accounts. This tab indicates the accounts served by the representative. Accounts can be added or deleted. Likewise, users can search for accounts to modify by using a search tool.

Users. This tab allows the administrator to create records for users, and to modify those records. Information such as names, titles, user status, contact information, and passwords can be entered and amended under this tab.

As the developer makes progress in testing and accepting samples, the database contains a listing of parts that have been designed into the project. At various stages during the development process, the developer is able to obtain a preliminary bill of materials. Thus, at an early stage, the preliminary bill of materials comprises parts samples that have been requested, while at later stages the bill of materials is more definite, comprising parts that have been designed in. At either stage, the present invention provides an easy tool to allow developers to compile a bill of materials. The bill of materials can be printed or electronically sent to other users.

Users can also request additional services in addition to requesting parts samples. While requesting and providing parts is a primary activity in the development or products, developers may need additional services as well. For example, an engineer may require design assistance in the project or technical support related to a requested sample. As yet other examples, a developer may want to receive quotes for purchases of parts in specific quantities or information regarding required lead times. In these or other cases, the developer can request such services in addition to (or instead of) requesting parts. The services are requested in any of several ways, including requesting them with a sample request, requesting services as a step separate from parts requests, or making a request from a sample tracking log. In yet other alternatives, a feedback request can query the developer to determine whether certain services are desired.

The foregoing invention offers many advantages over prior methods for administering samples, to the extent existing samples are monitored at all. Using the system and method described above, the sample acquisition, tracking, and reporting process is automated. Customers are able to view and order samples from multiple manufacturers from a single location on the Internet, making the parts request process much simpler.

In addition, data related to projects, customers, manufacturers, and parts are stored in a database that allows the data to be retrieved and used by other parties and on later projects. Consequently, developers need not submit project information multiple times for each part ordered. The time saved for this aspect alone is enormous for projects having hundreds or thousands of parts. Likewise, all persons involved in the project or the manufacture or distribution of parts can view the status in a single location. The collection of information related to sample activity also ensures that those customers who obtain parts are all notified when a manufacturer changes or discontinues a part. Otherwise, there is substantial risk that a developer will design a product having obsolete or nonexistent parts.

The solicitation of feedback makes it easy to update the database and ensures that the status will be maintained frequently. Although the information stored in the database is timely and frequently updated, it involves far less effort than the haphazard and distributed methods previously used.

The system provides for valuable reporting that is impossible to obtain otherwise. Not only does the reporting ability allow manufacturers to view projects in development that may affect parts and materials purchases in the future, but it allows them to better manage distributors and manufacturer representatives.

Though the preferred embodiment has been described and illustrated above, it may be modified without departing from the sprit and scope of the invention. Accordingly, the scope of the invention should be determined by the claims that follow.

We claim:

1. A system for processing a request by a developer via a remote client for a sample item over a network, the system comprising:
a server configured for communication with the client over the network;
a software component executable by the server for receiving and processing an order for the item as requested by the client, wherein the client request includes details related to a project on which the sample item is to be used; and
a database accessible by the server, the database containing information about the items available.

2. The system of claim 1, wherein the sample item is a part or component for possible use in the project.

3. The system of claim 1, wherein the sample item is a material for possible use in the project.

4. The system of claim 1, wherein the project details are stored in the database.

5. The system of claim 4, wherein the project details comprise a project name.

6. The system of claim 4, wherein the project details comprise project contact information.

7. The system of claim 4, wherein the project details comprise a period of evaluation of the item by the developer.

8. The system of claim 4, wherein the project details comprise an expected quantity of usage of the item by the developer.

9. The system of claim 4, wherein the project details comprise contact information for one or more parties involved in the project.

10. The system of claim 4, wherein the server software component is configured to access the database and present available manufacturers and part numbers to the client and to process a request for the item selected.

11. The system of claim 4, wherein the server software component is configured to process a request for an item as specified by a part number submitted via the client.

12. The system of claim 11, wherein the server software component is further configured to determine whether the part number is valid.

13. The system of claim 4, wherein the database further comprises contact information for a fulfilling party that is to be notified when the item is requested.

14. The system of claim 13, wherein the server software component is configured to notify the fulfilling party that the item has been requested.

15. The system of claim 14, wherein the server software component is further configured to complete an item request form associated with the fulfilling party and the fulfilling party is notified by receiving the request form from the server.

16. The system of claim 14, wherein the fulfilling party is notified by electronic mail.

17. The system of claim 16, wherein the fulfilling party is the item manufacturer.

18. The system of claim 16, wherein the fulfilling party is a manufacturer's representative for the item.

19. The system of claim 16, wherein the fulfilling party is a distributor for the item.

20. The system of claim 16, wherein the server software component is further configured to notify one or more non-fulfilling parties that the item has been requested.

21. The system of claim 13, wherein the server software component is further configured to solicit item status information from the fulfilling party related to the requested item.

22. The system of claim 21, wherein the item status information is solicited by evaluating status information previously stored in the database and sending an electronic mail message from the server to the fulfilling party.

23. The system of claim 22, wherein the item status information comprises whether the item request has been viewed by the fulfilling party.

24. The system of claim 22, wherein the item status information comprises whether the item request has been approved for shipment to the customer.

25. The system of claim 22, wherein the item status information comprises an anticipated shipping date for the item.

26. The system of claim 22, wherein the item status information comprises whether the item request has been shipped by the fulfilling party.

27. The system of claim 22, wherein the item status information comprises a shipping track number related to the item requested.

28. The system of claim 22, wherein the item status information comprises whether there are any change notices associated with the item.

29. The system of claim 22, wherein the item status information is stored in the database.

30. The system of claim 21, wherein the server software component is further configured to send item status information to the developer.

31. The system of claim 21, wherein the server software component is further configured to solicit project feedback information from the developer related to the requested item.

32. The system of claim 30, wherein the project feedback information is solicited by evaluating feedback information previously stored in the database and sending an electronic mail message from the server to the developer.

33. The system of claim 31, wherein the project feedback information comprises whether the item has been received by the developer.

34. The system of claim 31, wherein the project feedback information comprises whether the item has been designed in to the project by the developer.

35. The system of claim 31, wherein the project feedback information comprises whether the item has been assigned an internal part number by the developer.

36. The system of claim 31, wherein the project feedback information is stored in the database.

37. The system of claim 31, wherein the server software component is further configured to send project feedback information to the fulfilling party.

38. The system of claim 30, wherein the server software component is further configured to access the database to present project feedback or item status information to the client.

39. The system of claim 37, wherein the server software component is further configured to enable a user to modify information stored in the database.

40. The system of claim 37, wherein the user is assigned an associated permission level and the server software component is further configured to limit the information the user may modify depending upon the permission level.

41. The system of claim 37, wherein the server software component is further configured to access the database and to present a portion of the stored information in a report.

42. A method for processing a request by a developer via a remote client for a sample item over a network, the method comprising:
communicating with the client over the network;
receiving an order for the item as requested by the client, wherein the client request includes details related to a project on which the sample item is to be used;
submitting the request to a fulfillment party; and
storing information related to the request in a database.

43. The system of claim 42, wherein the sample item is a part or component for possible use in the project.

44. The system of claim 42 wherein the sample item is a material for possible use in the project.

45. The system of claim 42, wherein the project details are stored in the database.

46. The system of claim 45, wherein the project details comprise a project name.

47. The system of claim 45, wherein the project details comprise project contact information.

48. The system of claim 45, wherein the project details comprise a period of evaluation of the item by the developer.

49. The system of claim 45, wherein the project details comprise an expected quantity of usage of the item by the developer.

50. The system of claim 45, wherein the project details comprise contact information for one or more parties involved in the project.

51. The system of claim 45, further comprising presenting available part numbers to the developer for possible selection by the developer.

52. The system of claim 45, wherein receiving the order comprises receiving a part number submitted from the developer.

53. The system of claim 52, further comprising determining whether the submitted part number is valid.

54. The system of claim 45, wherein the fulfilling party is the item manufacturer.

55. The system of claim 45, wherein the fulfilling party is a manufacturer's representative for the item.

56. The system of claim 45, wherein the fulfilling party is a distributor for the item.

57. The system of claim 45, further comprising notifying one or more non-fulfilling parties that the item has been requested.

58. The system of claim 45, further comprising soliciting item status information from the fulfilling party related to the requested item.

59. The system of claim 58, wherein the item status information is solicited by evaluating status information previously stored in the database and sending an electronic mail message from the server to the fulfilling party.

60. The system of claim 59, wherein the item status information comprises whether the item request has been viewed by the fulfilling party.

61. The system of claim 59, wherein the item status information comprises whether the item request has been approved for shipment to the customer.

62. The system of claim 59, wherein the item status information comprises an anticipated shipping date for the item.

63. The system of claim 59, wherein the item status information comprises whether the item request has been shipped by the fulfilling party.

64. The system of claim 59, wherein the item status information comprises a shipping track number related to the item requested.

65. The system of claim 59, wherein the item status information comprises whether there are any change notices associated with the item.

66. The system of claim 59, wherein the item status information is stored in the database.

67. The system of claim 58, further comprising sending item status information to the developer.

68. The system of claim 58, further comprising sending project feedback information from the developer related to the requested item.

69. The system of claim 68, wherein the project feedback information is solicited by evaluating feedback information previously stored in the database and sending an electronic mail message from the server to the developer.

70. The system of claim 69, wherein the project feedback information comprises whether the item has been received by the developer.

71. The system of claim 69, wherein the project feedback information comprises whether the item has been designed in to the project by the developer.

72. The system of claim 69, wherein the project feedback information comprises whether the item has been assigned an internal part number by the developer.

73. The system of claim 69, wherein the project feedback information is stored in the database.

74. The system of claim 69, further comprising sending project feedback information to the fulfilling party.

75. The system of claim 69, further comprising accessing the database to present project feedback or item status information to the client.

76. A system for processing a request by a developer via a remote client for a sample item over a network, the system comprising:
a server configured for communication with the client over the network;
a software component executable by the server for receiving and processing an order for the item as requested by the client, wherein the client request includes details related to a project on which the sample item is to be used;
a database accessible by the server, the database containing information about the items available; and
a software component executable by the server to determine whether the requested sample requires a plurality of parties to be notified and to notify a plurality of parties that the sample has been requested.

77. A method for processing a request by a developer via a remote client for a sample item over a network, the method comprising:
communicating with the client over the network;
receiving an order for the item as requested by the client, wherein the client request includes details related to a project on which the sample item is to be used;
determining the parties to be notified of the sample request; and
notifying one or more parties, as determined to be appropriate.

78. The method of claim 77, wherein determining the parties to be notified further comprises accessing a database associating the requested sample with parties to be notified.

79. A method for preparing a bill of materials, the method comprising:
accessing a database of sample items requested for potential use in a project;
determining whether any of the sample items have been designated as approved for use; and
preparing a bill of materials.

80. The method of claim 79, wherein the bill of materials includes all sample items designated as approved for use.

81. The method of claim 80, wherein the bill of materials further includes requested sample items that have not been designated as approved for use.

82. A method of electronically populating an item request form to be submitted to one of a plurality of fulfilling parties, the method comprising:
determining whether there is a particular form preferred by the fulfilling party; and
completing the form by obtaining information associated with the item request and entering it in appropriate fields within the form.

83. The method of claim 82, wherein the form that is completed is the form preferred by the fulfilling party.

84. The method of claim 82, wherein the form that is completed is a generic form.

85. The method of claim 82, wherein the step of completing the form further comprises indicating the time and date of the item request.
